(19) United States
(12) Patent Application Publication
(10) Pub. No.: US 2007/0259086 A1
(43) Pub. Date: Nov. 8, 2007

(54) Device for treating fruit

(75) Inventor: Philippe Blanc, Montauban (FR)

Correspondence Address: YOUNG & THOMPSON, 745 SOUTH 23RD STREET, 2ND FLOOR, ARLINGTON, VA, 22202, US

(73) Assignee: MATERIEL POUR L'ARBORICULTURE FRUITIERE, MONTAUBAN (FR)

(21) Appl. No.: 11/730,834

(22) Filed: Apr. 4, 2007

(30) Foreign Application Priority Data
Apr. 5, 2006 (FR) 06.02988

(51) Int. Cl. A23L 1/00

(52) U.S. Cl. 426/479

(57) ABSTRACT

The invention relates to a device for treating fruit of the type comprising at least one hydraulic circuit provided with at least one pump (2) sucking up a neutral liquid with fruit to be treated. According to the invention, at least one internal wall of a pump (2) of the circuit is covered by a non-metallic shock-resistant coating of lower hardness than a metal wall.

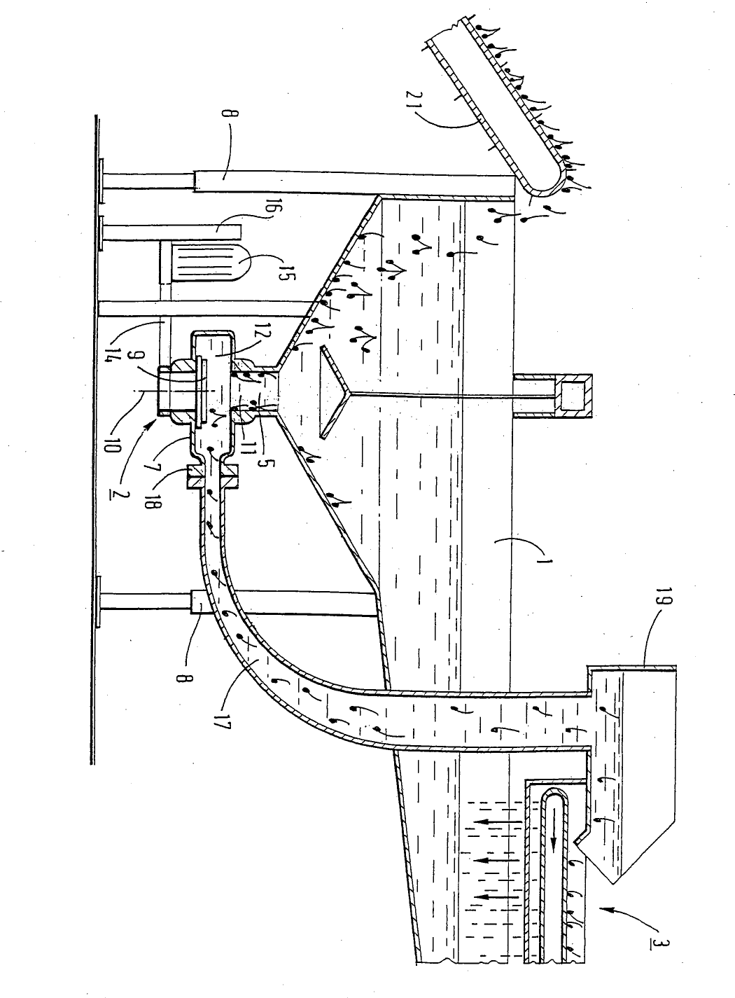

### FIELD OF THE INVENTION

The invention relates to a device for treating fruit of the type comprising at least one hydraulic circuit provided with at least one pump sucking up a neutral liquid with fruit to be treated.

In particular, the invention relates to devices for separating the stalks of fruit such as cherries, grouped together in clusters, from one another at their joining point. Such devices allow the fruit to be automatically separated in order to isolate them which then allows the sorting and/or packaging operations to be facilitated.

### BACKGROUND OF THE INVENTION

FR 2820287 has already disclosed such a device comprising a tank with a base which is inclined as far as a lower lateral outlet orifice connected to a centrifugal hydraulic pump. The discharge pipe of the pump returns the water and the fruit to an element for collecting and distributing the cherries after separation. This document teaches that, in specific conditions, the use of the pump with a free passage section of greater than 45 mm and at low speed, allows the stalks of the fruit to be separated due to the specific hydraulic stresses undergone by the fruit inside a chamber of the pump.

Specifically, during their passage in this chamber, it is not impossible that some fruits are able to come into contact with the walls, known as internal walls, located in the chamber of the pump, in particular walls of the pump blades and walls of the pump housing defining the internal chamber. In particular, the fruit may be caught on the upper, often sharp, edge of the blades driven in rotation or may be projected onto fixed walls of the pump housing by the liquid being moved in the pump chamber.

It is noteworthy that it is not necessary for the impact to be essentially frontal to produce a significant deterioration of the fruit. More specifically, rubbing the surface of the fruit on the abrasive walls of the pump may, due to the speed able to be reached by the fruit inside the pump, produce scratches which, even of small size, affect their appearance and are susceptible to bacterial growth or fungal development which is liable to shorten the length of storage time of the fruit.

Specifically, the centrifugal pumps are often formed, at least partially, from cast parts having hard walls, sharp edges and a surface quality which is abrasive for the fruit.

It is known from FR 2820287 to limit the speed of rotation of the pump to a level which is lower than its nominal functioning speed. Nevertheless, the adjustment of such a device poses a problem, especially when high treatment rates are desired. More specifically, from a certain rotational speed a significant proportion of fruit comes into contact with the walls of the housing or wheel of the pump and is therefore damaged. However, if the speed of the pump is too low, the efficiency of the separation of the stalks is unsatisfactory, the proportion of unseparated stalks remaining high at the outlet of the pump.

### SUMMARY OF THE INVENTION

The invention, therefore, aims to alleviate these drawbacks by proposing a device which makes it possible to ensure both high efficiency of the separation of the stalks, whilst obtaining a high rate of treated fruit, in particular so as to be compatible with supplying industrial sorters, the treatment rate thereof being able to reach 2 t/h.

In particular, the invention aims to reduce the severity of the deterioration to which the fruit may be subjected during the contact of the fruit with the walls of the pump during the passage of the fruit in the pump chamber.

The invention aims, furthermore, to propose such a simple and inexpensive device, both in terms of manufacturing costs and usage costs.

To achieve this, the invention relates to a device for treating fruit of the type comprising at least one hydraulic circuit provided with at least one pump sucking up a neutral liquid with fruit to be treated, characterised in that at least one internal wall of a pump coming into contact with the liquid transporting the fruit is covered by a non-metallic coating, known as a shock-resistant coating of lower hardness than that of a solid metal wall.

Consequently, in the event of an impact between a fruit and such an internal wall covered by a shock-resistant coating, the crushing undergone by the fruit is reduced. Thus less deterioration of the fruit results. Advantageously, and according to the invention, said shock-resistant coating is of lower hardness than that of the wall which it covers.

Furthermore, and according to the invention, said shock-resistant coating has a surface quality of lower roughness than that of a wall of a metal part made by casting. Throughout the text, the expression “surface quality” denotes, for the shock-resistant coating, the surface quality of the surface of the shock-resistant coating when it comes into contact with the liquid transporting the fruit. In particular, advantageously and according to the invention, said shock-resistant coating has a surface quality of lower roughness than that of the metal wall which it covers. In particular, due to the fact that the surface of the coating coming into contact with the liquid transporting the fruit is less rough, i.e. more smooth, in the event of impact of a fruit on this surface, the risks of damage to the fruit are minimised. In particular, the coefficient of dynamic friction of the fruit relative to this surface of the coating is substantially less than the coefficient of dynamic friction of the fruit on an internal metal wall of the pump.

Advantageously and according to the invention:
said shock-resistant coating covers at least one edge of the internal wall of the pump,
said shock-resistant coating has a surface in contact with the liquid transporting fruit with a greater radius of curvature than that of the edge which it covers.

Advantageously and according to the invention, the surface of the shock-resistant coating is rounded in the region of an edge which it covers. Consequently, the device according to the invention is less likely to cut a fruit, in the event of this fruit coming into contact with an area of the internal wall of the pump having an edge, during its passage in the pump chamber.

Advantageously and according to the invention, said shock-resistant coating has a radius of curvature greater than 1 mm at any point of its surface in contact with the liquid transporting the fruit. Preferably, the radius of curvature is greater than 2.5 mm at any point of this surface.

Advantageously and according to the invention, said shock-resistant coating has a thickness of between 150 and 1500 micrometres. Preferably, advantageously and according to the invention, said shock-resistant coating has a thickness of between 500 and 1500 micrometres.

Advantageously and according to the invention, the shock-resistant coating is a food-grade thermoplastic paint.

In particular, the shock-resistant coating may be formed from a coating adapted to the material of the internal wall, to the surface quality of this wall and to the chemical and thermal qualities of the liquid circulating in the pump so as to be able to last without flaking, eroding or corroding during the functioning of the device according to the invention. More specifically, apart from the possible reduction of the beneficial effects obtained from the shock-resistant coating due to such wear, the distribution of particles of the shock-resistant coating in the neutral liquid and the possible deposit of these particles on the fruit inside the filtration device, could make the treated fruit unfit for consumption.

Preferably, the shock-resistant coating also has a low toxicity such that in the event of excessive wear or undetected accidental deterioration of the shock-resistant coating, the resulting contamination does not present substantial health risks for the consumer.

Advantageously and according to the invention, each internal mobile member of each pump of the circuit has a shock-resistant coating on each of its walls coming into contact with the liquid transporting the fruit.

In particular, each pump wheel has a shock-resistant coating on its walls coming into contact with the liquid transporting the fruit to be treated.

Similarly, advantageously and according to the invention, each internal wall of a housing of the pump of the circuit defining a chamber passed through by the liquid transporting the fruit is covered by a shock-resistant coating.

In particular, the pump housing may be covered by a shock-resistant coating over its entire internal surface coming into contact with the liquid transporting the fruit.

In a preferred embodiment, advantageously and according to the invention, each of the walls of a wheel and of a housing of each pump coming into contact with the liquid transporting the fruit is integrally covered by a shock-resistant coating.

Advantageously and according to the invention, the circuit comprises a pump of the vortex centrifugal pump type, i.e. with a wheel retracted relative to the pump housing, such that a space is made axially between the wheel and the pump housing for the passage of the liquid and the fruit to be treated.

Preferably, the centrifugal pump is a single-stage pump, i.e. with a single wheel.

The invention also relates to a device characterised in combination by all or some of the features mentioned above or below.

### BRIEF DESCRIPTION OF THE DRAWING

Further features, objects and advantages of the invention will become apparent from reading the following description which refers to the single accompanying FIGURE which is a schematic view in section through a vertical longitudinal plane of a preferred embodiment of a device for separating the stalks of fruit such as cherries, grouped together in clusters, from one another at their joining point, according to the invention.

### DETAILED DESCRIPTION OF THE INVENTION

A device according to the invention comprises at least one hydraulic circuit receiving a volume of neutral liquid carrying along the fruit to be treated.

In a preferred embodiment of a device according to the invention, the hydraulic circuit of the device comprises a main tank 1 containing a volume of neutral liquid such as water or a food-grade aqueous solution, a centrifugal pump 2 connected to the tank 1 for sucking up the liquid therefrom and the fruit contained in this liquid, and a downstream filtration device 3 receiving the liquid and the fruit discharged by the pump 2, and capable of separating the fruit from the liquid. The fruit may be fed continuously into the tank 1 by a conveyor 21 driven in continuous motion and emptying the fruit into the upper part of the tank 1.

The tank 1 may, for example, be formed by a trough with walls made of metal or of rigid synthetic material, carried by a rigid frame resting on the ground by means of feet, such as at 8.

In the preferred embodiment shown, the tank 1 has an outlet orifice 5 discharging above the pump 2 which is arranged with its vertical axis below this orifice 5. The orifice 5 is arranged in the lower part of the tank so as to encourage, under the effect of gravity, the driving of the liquid contained in the tank 1 and the fruit towards this orifice 5 by suction produced by the pump 2.

In the preferred embodiment, the pump 2 is a centrifugal pump which comprises a housing 7 fixed rigidly to the frame and defining a chamber housing a mobile pumping wheel 9 guided in rotation relative to the housing 7 along an axis 10 of rotation. Preferably, the housing 7 of the pump is fixed to the frame such that the axis 10 of rotation is oriented at least substantially vertically, coaxial to the axis of the lower orifice 5 of the tank 1.

In a variant not shown, the pump 2 may also be arranged so that the axis 10 of rotation is oriented at least substantially horizontally or obliquely.

The pump 2 has an axial suction inlet 11, arranged opposite the axis 10 of rotation of the wheel. Moreover, the wheel 9 which extends immediately below the suction inlet 11 is retracted relative to this suction inlet 11, an axial space 12 of the chamber being made between the housing 7 of the pump 2 and this wheel 9.

The suction inlet 11 may be connected to the outlet orifice 5 of the tank 1, below this outlet orifice 5, by a short suction pipe.

The housing 7 of the pump 2 comprises a discharge outlet 18 arranged on the periphery of the housing 7 and radially oriented relative to the wheel 9.

In the preferred embodiment, the pump 2 is driven in rotation by a belt 14, itself coupled to an electric motor 15 fixed to a support 16 resting on the ground. This belt 14 is directly coupled at the end of the shaft to the wheel 9.

After starting up the motor and driving the wheel by means of the belt, the liquid and the fruit are sucked up from the tank 1 as far as the interior of the chamber of the pump 2, then ejected towards the discharge outlet 18. A discharge pipe 17 of the device is attached to the discharge outlet 18 so as to allow the conveyance of the liquid and the discharged fruit as far as a discharge tank 19.

This discharge pipe 17 may have a cross-section which increases from the discharge outlet 18 of the pump 2 as far as the discharge tank 19, such that the liquid and the fruit circulate in this pipe at a reducing speed. Ideally, the fruit arrives at the discharge tank 19 at a speed which is as low as possible. In this manner, the risks of impact and damage to the fruit in this pipe 17 are minimised. The tank 19 comprises a horizontal base and lateral walls and is open at the top and suitable for being able to contain a specific volume of liquid and fruit for emptying them gently onto a filtration conveyor 3. This conveyor 3 is driven in continuous motion and has a perforated conveyor belt suitable for holding the fruit and allowing the liquid to pass vertically through the entire conveyor 3. The fruit is, therefore, carried along by the belt into the outlet of the device and the liquid returns to the tank 1 which has a base immediately below the filtration conveyor 3 to collect this liquid.

In such a device, from a specific speed of rotation of the wheel of the pump, which is generally less than the nominal speed of rotation of this pump, the separation of the stalks at their joining point is carried out entirely due to the specific hydraulic stresses undergone by the fruit inside the chamber, in particular in the axial space 12.

The wheel 9 and the housing 7 of the pump 2 are formed from metal parts made by casting. The internal walls of this pump 2 are covered by a layer of a food-grade thermoplastic shock-resistant coating, increasing the thickness of the constituent parts of the housing 7 and of the wheel 9, rounding the edges and sharp angles of these parts and improving their surface quality by making them more smooth and less hard.

For example, the pump 2 may be a pump marketed under the trade name SEWABLOC® F100-250 by the firm KSB (Cenon, France or www.ksb.com) achieving a rate of 100 m3/h for a height of 12 metres.

The shock-resistant coating may be formed from a polymeric composite, provided in powder form, marketed under the trade name PLASCOAT® PPA 571 HES by the firm PLASCOAT SYSTEMS LTD (Farnham, UK).

To produce the shock-resistant coating on the internal walls of the pump 2, firstly the step of dismantling this pump is undertaken. The shock-resistant coating of the wheel 9 of the pump may thus be produced independently of the shock-resistant coating of the housing 7.

If required, certain parts forming the pump housing may also be dismantled so that the coating of these parts may be carried out independently. In the case of a pump of the SEWABLOC® F100-250 type, for example, the housing of the pump may be dismantled such that a first portion, known as the rear portion, extending radially about the axis 10 of rotation of the wheel 9 is separated from a second portion, known as the shell, extending radially about the suction inlet 11.

A step of shot-blasting the surfaces of the parts to be covered is then carried out such that, following this step, these surfaces have a roughness of between 6 and 12 micrometres. If required, this step allows the removal of paints and other surface treatments previously carried out on the parts to be coated with the shock-resistant coating.

A step of freeing dust from the parts to be coated is then carried out. This step may be carried out by blowing dry air and by brushing with a soft brush so as to remove any non-adhesive foreign bodies (calamine and/or oxide chips, residues of abrasive, dust, etc).

A step for applying the coating is then carried out. In this step, the PLASCOAT® powder is applied to the parts to be coated with an electrostatic gun with negative polarity. The parts are then placed and heated in an oven at 200 degrees Celsius for 20 minutes. The melted powder then leaves a smooth coating.

It is noteworthy that the application of a shock-resistant coating on the rear base allows this part to be of food-grade quality. This has an advantage, to the extent that the rear base, even if it is not capable of receiving contact with the fruit, is nevertheless intended to come into contact with the neutral liquid.

Moreover, this shock-resistant coating allows the oxidation of the metal parts of the pump to be avoided, which may create, in particular, an undesirable discolouration of the liquid.

After a cooling step, the pump may be reassembled and operated inside a device according to the invention.

Such a method for modifying the pump allows a shock-resistant coating to be formed on the wheel 9 and on the walls of the wheel 9 and the walls of the housing 7, which has an essentially uniform thickness.

The shock-resistant coating has a rounded surface in the region of possible edges or smooth or sharp edges of the pump in addition to a surface of lower hardness and roughness in the region of the internal walls of the pump.

The pump thus modified may be used, for example, at 40% of its nominal speed to treat the cherries and separate their stalks at their joining point. With such a device according to the invention, all the cherries are isolated and said cherries undergo no appreciable deterioration. Thus the device according to the invention allows the rate of treated fruit to be improved without increasing the risk of deterioration of the fruit during their passage in the circuit.

The inventor has been able to observe that the presence of the shock-resistant coating in the pump chamber 2, in particular on the vanes of the wheel 9 and on the shell of the pump housing 2, does not cause a loss of efficiency of the pump 2 from the point of view of its pumping characteristics, liable to impair the efficiency of the device of the invention.

Typically, the PLASCOAT® may be applied so as to have a thickness of between 150 micrometres and 1500 micrometres. In particular, the inventor has been able to verify that it is possible to obtain good results by means of a pump, of which the shock-resistant coating has an average thickness in the range of 500 to 1500 micrometres. Further values are nevertheless possible, depending on the coating used and depending on the general shapes and dimensions of the pump used and of the device according to the invention.

The inventor has also been able to verify that the shock-resistant coating thus formed is suitable for lasting without flaking, eroding or corroding during the functioning of the device equipped with the pump. Furthermore, the shock-resistant coating used is of food-grade quality.

The device according to the invention may form the subject of numerous variants.

In particular, it is possible to make the device according to the invention by modifying pumps other than a pump with a single wheel 9 (single-stage) of the vortex type, mounted to be axially retracted. In particular, the pump may be provided with one or more wheels of the single-channel or multi-channel type.

Furthermore, the pump of the device according to the invention may be a pump specifically designed and manufactured to comprise at least one wall covered by a shock-resistant coating with the view to being used inside devices for treating fruit in accordance with the invention.

Moreover, the distribution of a shock-resistant coating on the parts of the pump may be other than that disclosed for the preferred embodiment of the invention. In particular, nothing is to prevent one part of the internal walls of the pump located in the pump chamber and coming into contact with the liquid transporting the fruit to be treated, from being covered by a shock-resistant coating. For example, a shock-resistant coating may be made solely on the wheel, the internal walls of the housing of the pump being excluded from the shock-resistant coating. In contrast, in a variant, only the internal walls of the housing coming into contact with the liquid and the fruit to be treated may be covered by a shock-resistant coating (in particular if the selected pump makes it possible to ensure that there is no risk of contact of the fruit with the wheel).

It is noteworthy that it is also possible to cover only certain portions of the surface of the internal walls of the wheel 9 or of the housing 7, preferably the portions most liable to damage the fruit, in particular the edges or sharp edges or abrasive surfaces of the pump.

In this regard, it is noteworthy that it is possible to apply the shock-resistant coating other than by means of a gun with negative polarity. More specifically, it is possible to carry out this application in any manner suitable for the type of shock-resistant coating used, in particular by the application by means of vacuum depositing, by spraying a lacquer or paint, by dipping the parts, etc.

Moreover, the shock-resistant coating may be formed by any malleable paint or coating, in liquid or powder form, suitable for adhering to the wall to be coated and to be able to form, after adhering to this wall, a shock-resistant coating according to the invention. In particular, the shock-resistant coating may be not the thermoplastic type, but, in contrast, the thermosetting type.

Nothing prevents the application of different types of shock-resistant coatings to different walls or even the superposing of a plurality of layers of different or similar shock-resistant coatings on the same wall.

The invention may be applied to a device for separating the stalks of fruit, grouped together in clusters, from one another at their joining point, similar to that of the preferred embodiment disclosed above, but of which the separation of the stalks is not carried out, or at least not entirely, in the axial space 12 of the chamber of the pump 2. In particular, the invention may be applied to such a device in which the separation of the stalks at their joining point is carried out in a specific hydraulic device for separating the stalks, for example in a pipe in which whirlpools or a vortex are generated by means of a pump to which the pipe is connected. In such a device, the fruit is actually made to pass through the chamber of the pump.

Moreover, the invention may be applied to devices for treating fruit other than those intended for the separation of the stalks. In particular, the invention may be applied to a device for cooling fruit, or any other device for treating fruit to the extent that it comprises at least one hydraulic circuit provided with at least one pump sucking up a neutral liquid transporting fruit to be treated such that it causes the fruit to pass through the chamber of the pump.

1. Device for treating fruit of the type comprising at least one hydraulic circuit provided with at least one pump sucking up a neutral liquid with fruit to be treated, wherein at least one internal wall of a pump coming into contact with the liquid transporting the fruit is covered by a non-metallic coating, known as a shock-resistant coating of lower hardness than that of a solid metal wall.

2. Device as claimed in claim 1, wherein said shock-resistant coating is of lower hardness than that of the wall which it covers.

3. Device as claimed in claim 1, wherein said shock-resistant coating has a surface quality of lower roughness than that of a wall of a metal part made by casting.

4. Device as claimed in claim 1, wherein said shock-resistant coating has a surface quality of lower roughness than that of the metal wall which it covers.

5. Device as claimed in claim 1, wherein
said shock-resistant coating covers at least one edge of the internal wall of the pump,
said shock-resistant coating has a surface in contact with the liquid transporting fruit with a greater radius of curvature than that of the edge which it covers.

6. Device as claimed in claim 1, wherein said shock-resistant coating has a radius of curvature greater than 1 mm at any point of its surface in contact with the liquid transporting the fruit.

7. Device as claimed in claim 1, wherein said shock-resistant coating has a thickness of between 150 and 1500 micrometres.

8. Device as claimed in claim 1, wherein said shock-resistant coating is formed by a food-grade thermoplastic paint.

9. Device as claimed in claim 1, wherein each internal mobile member of each pump of the circuit has a shock-resistant coating on each of its walls coming into contact with the liquid transporting the fruit.

10. Device as claimed in claim 1, wherein each internal wall of a housing of the pump of the circuit defining a chamber passed through by the liquid transporting the fruit is covered by a shock-resistant coating.

11. Device as claimed in claim 1, wherein each of the walls of a wheel and of a housing of each pump coming into contact with the liquid transporting the fruit is integrally covered by a shock-resistant coating.

12. Device as claimed in claim 1, wherein the circuit comprises a pump of the vortex centrifugal pump type.

13. Device as claimed in claim 2, wherein said shock-resistant coating has a surface quality of lower roughness than that of a wall of a metal part made by casting.

14. Device as claimed in claim 2, wherein said shock-resistant coating has a surface quality of lower roughness than that of the metal wall which it covers.

15. Device as claimed in claim 2, wherein
said shock-resistant coating covers at least one edge of the internal wall of the pump,
said shock-resistant coating has a surface in contact with the liquid transporting fruit with a greater radius of curvature than that of the edge which it covers.

16. Device as claimed in claim 2, wherein said shock-resistant coating has a radius of curvature greater than 1 mm at any point of its surface in contact with the liquid transporting the fruit.

17. Device as claimed in claim 2, wherein said shock-resistant coating has a thickness of between 150 and 1500 micrometres.

18. Device as claimed in claim 2, wherein said shock-resistant coating is formed by a food-grade thermoplastic paint.

19. Device as claimed in claim 2, wherein each internal mobile member of each pump of the circuit has a shock-resistant coating on each of its walls coming into contact with the liquid transporting the fruit.

20. Device as claimed in claim 2, wherein each internal wall of a housing of the pump of the circuit defining a chamber passed through by the liquid transporting the fruit is covered by a shock-resistant coating.
